(19) United States
(12) Patent Application Publication
(10) Pub. No.: US 2026/0316639 A1
(43) Pub. Date: Oct. 15, 2026

(54) CHILD RESTRAINT SYSTEM WITH HEADREST ADJUSTMENT INDICATOR

(71) Applicant: Wonderland Switzerland AG, Steinhausen (CH)

(72) Inventors: Andrew J. Taylor, Mohnton, PA (US); Andrew J. Horst, Morgantown, PA (US); Zachary C. Hartenstine, Ephrata, PA (US)

(73) Assignee: Wonderland Switzerland AG, Steinhausen (CH)

(21) Appl. No.: 19/461,832

(22) Filed: Jan. 28, 2026

Related U.S. Application Data
(60) Provisional application No. 63/751,526, filed on Jan. 30, 2025.
(60) Provisional application No. 63/875,554, filed on Sep. 4, 2025.

(51) Int. Cl. B60N 2/28

(52) U.S. Cl. CPC B60N 2/2851; B60N 2/2812; B60N 2/2872; B60N 2/2869; B60N 2/2875

(57) ABSTRACT

The present disclosure is directed towards a child restraint system, including a child car seat, positionable on a vehicle seat includes an adjustable headrest and an indicator for showing the specific position of the headrest.

### CROSS-REFERENCE TO RELATED APPLICATIONS

This application claims the benefit of and priority to U.S. Provisional Application No. 63/875,554, filed Sep. 4, 2025, and U.S. Provisional Application No. 63/751,526, filed Jan. 30, 2025, the entire disclosures of which are incorporated by reference into this application.

### TECHNICAL FIELD

Embodiments of the present disclosure relate to child restraint systems for use in a vehicle, and more particularly to child car seats having headrest adjustment indicators.

### BACKGROUND

Conventional car seats include headrests that can change between different positions (height) to accommodate a size of a child. In addition, some child car seats currently available on the market have multiple use configurations that allow for the seats to continue to be used as a child grows. For example, some child car seats can be selectively used in any one or more of: (1) a rear facing, reclined configuration for infants, (2) a forward facing, reclined configuration for toddlers, (3) a forward facing, high-back booster configuration for children weighing between, e.g., 40 pounds and 100 pounds, and (4) a forward facing, backless booster configuration for children weighing between, e.g., 40 pounds and 120 pounds. To accommodate the various heights of different children, a headrest is vertically adjustable. However, it can be difficult for a caregiver to determine the correct height for a different child, for example when different children use a seat at different times. Likewise, it can be difficult to communicate the correct headrest height to a caregiver who is unfamiliar with using the seat. In addition, for crash testing of a car seat, consistent headrest placement is critical to compare results of multiple tests. The car seat should be consistently set up in the same position for each test. The positions are often unmarked, making consistent placement into a specific position difficult. For crash testing, consistent headrest placement is critical, thus markings could be used to ensure car seats are consistently set up in the same position for each test.

### SUMMARY

An embodiment of the present disclosure includes a child restraint system. The child restraint system includes a base configured for securement to a seat in a vehicle. The system also includes a child seat coupled to the base, the child seat having a seat portion and a seat back panel. The system also includes a headrest movably mounted to the seat back panel, where the headrest is adjustable to a plurality of positions relative to the seat back panel. The system also includes one or more height indicators for showing in which of the plurality of positions the headrest is placed relative to the seat back panel.

In an embodiment of the child restraint system, the one or more height indicators is aligned with the seat back panel.

In the embodiment of the child restraint system, the one or more height indicators is disposed along or aligned with a lower portion of the headrest.

In the embodiment of the child restraint system, one or more height indicators is located behind the softgoods.

In the embodiment of the child restraint system, one or more height indicators is located along an edge of the seat back panel.

In the embodiment of the child restraint system, one or more height indicators is located on the softgoods.

In the embodiment of the child restraint system, a majority of one or more height indicators is obstructed by the headrest when the headrest is in its lowermost position of the plurality of positions.

In the embodiment of the child restraint system, a majority of one or more height indicators is exposed when the headrest is in its highest position of the plurality of positions.

In the embodiment of the child restraint system, one or more height indicators includes a plurality of markings separated by fixed spacings between adjacent markings.

In the embodiment of the child restraint system, the plurality of markings are alphanumeric characters.

In the embodiment of the child restraint system, the plurality of positions are distinct positions of the headrest relative to the seat back panel.

In the embodiment of the child restraint system, actuation of an actuator causes the headrest to move among any one of the plurality of positions.

In the embodiment of the child restraint system, the child restraint system may include a harness assembly for restraining a child within the child seat.

An embodiment of the present disclosure is a child car seat. The child car seat also includes a seat portion. The seat also includes a seat back panel. The seat also includes a headrest movably mounted to the seat back panel, where the headrest is adjustable to a plurality of positions relative to the seat back panel. The seat also includes one or more height indicators for showing in which of the plurality of positions the headrest is placed relative to the seat back panel.

In the embodiment of the child car seat, the one or more height indicators is aligned with the seat back panel.

In the embodiment of the child car seat, the one or more height indicators is disposed along or aligned with a lower portion of the headrest.

In the embodiment of the child car seat, the one or more height indicators is located behind the softgoods.

In the embodiment of the child car seat, the one or more height indicators is located along an edge of the seat back panel.

In the embodiment of the child car seat, the one or more height indicators is located on the softgoods.

In the embodiment of the child car seat, the majority of one or more height indicators is obstructed by the headrest when the headrest is in its lowermost position of the plurality of positions.

In the embodiment of the child car seat, the majority of one or more height indicators is visually exposed when the headrest is in its highest position of the plurality of positions.

In the embodiment of the child car seat, the one or more height indicators includes a plurality of markings separated by fixed spacings between adjacent markings.

In the embodiment of the child car seat, the plurality of markings are alphanumeric characters.

In the embodiment of the child car seat, the plurality of positions are distinct positions of the headrest relative to the seat back panel.

In the embodiment of the child car seat, actuation of the actuator causes the headrest to move among any one of the plurality of positions.

### BRIEF DESCRIPTION OF THE DRAWINGS

The foregoing summary, as well as the following detailed description of illustrative embodiments of the present application, will be better understood when read in conjunction with the appended drawings. For the purposes of illustrating the present application, there is shown in the drawings illustrative embodiments of the disclosure. It should be understood, however, that the application is not limited to the precise arrangements and instrumentalities shown.

In the drawings:

FIG. 1 is a perspective view of a child restraint system according to an embodiment of the present disclosure, with softgoods removed for illustrative purposes;

FIG. 2 is a front view of the child restraint system shown in FIG. 1;

FIG. 3 is a side view of the child restraint system shown in FIG. 1;

FIG. 4 is a front view of the child restraint system shown in FIG. 1, illustrating a headrest in the lowermost position;

FIG. 5 is a front view of the child restraint system shown in FIG. 1, illustrating a headrest in an intermediate position;

FIG. 6 is a front view of the child restraint system shown in FIG. 1, illustrating a headrest in an intermediate position;

FIG. 7 is a front view of the child restraint system shown in FIG. 1, illustrating a headrest in a highest position;

FIG. 8 is a perspective view of a child restraint system, with softgoods, according to another embodiment of the present disclosure, with the headrest in an intermediate position; and

FIG. 9 is a front view of the child restraint system shown in FIG. 8, illustrating a headrest in its highest position.

### DETAILED DESCRIPTION

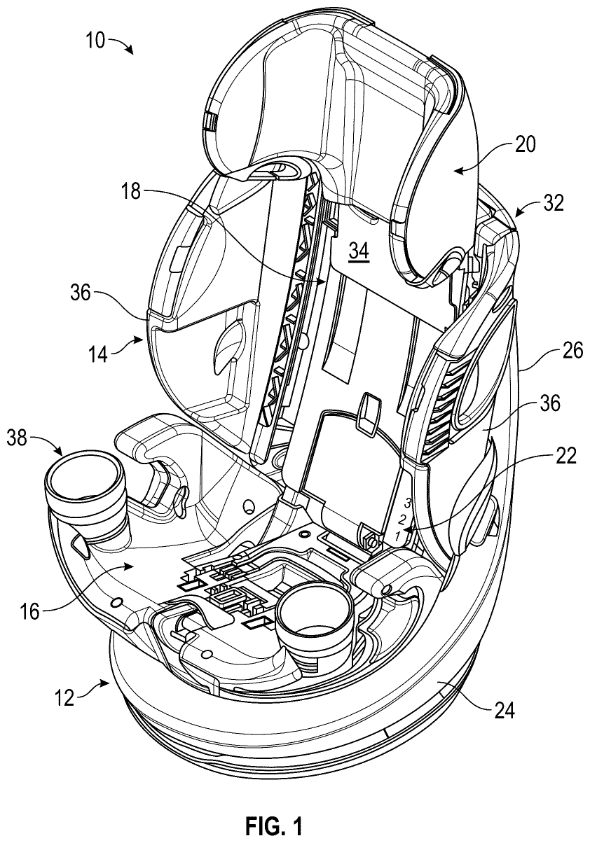

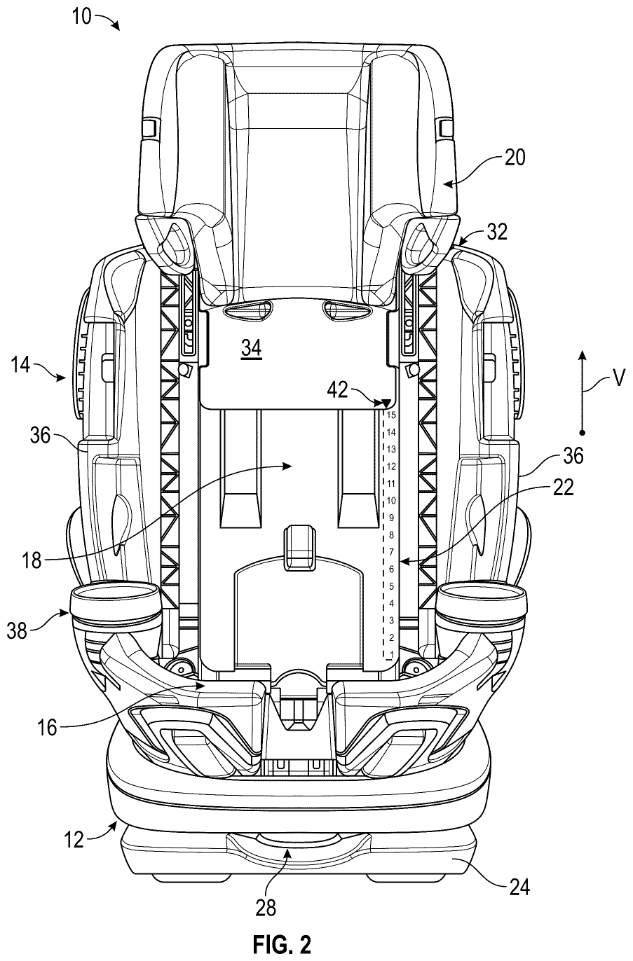

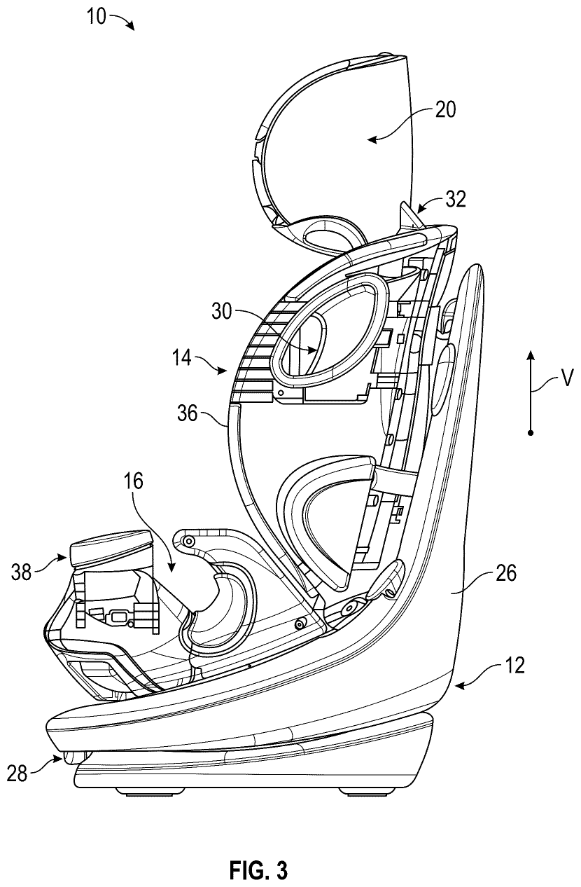

As shown in FIGS. 1-3, embodiments of the present disclosure include a child restraint system 10 having a support base 12 and car seat 14 associated with the support base 12. The car seat 14 includes a seat 16, a seat back panel (or assembly) 18, and a headrest 20 that is movable relative to the back panel 18. The car seat 14 may include one or more height indicators 22 that is used to identify a specific height position of the headrest 20 relative to the seat back panel 18. More specifically, the headrest 20 is adjustable to a plurality of positions relative to the seat back panel 18 and the height indicator(s) 22 can display which one of the plurality of positions the headrest 22 is placed relative to the seat back panel 18. The positions of the headrest 20 may be distinct positions. This in turn allows the car seat 14 to be adjusted to account for growth of the child so the headrest 20 is in the proper position for that child thereby ensuring that the safety protocols and features built into the child restraint system 10 are appropriately matched to the size of the user in the car seat 14.

The headrest 20 and height indicator 22 as described herein could be used for a number of different child restraint systems and child seats, such as those disclosed in WO 2024/206806, entitled “Child Vehicle Seat System,” the entire contents of which are incorporated by reference into the present disclosure. However, other variations of a child restraint system and car seat could be used and the child restraint system and car seat disclosed in the present application are not the only types of such systems contemplated by the inventors as included within the scope of the present disclosure or claims.

Referring to FIGS. 1-3, the support base 12 can be detachably fixed to a vehicle seat, such as via a latch or anchor mechanism, not shown in the figures. This latch or anchor system often used is sometimes referred to as a “lower anchor and tether for children” e.g., LATCH system. Alternatively, or in addition, the support base 12 may be detachably fixed to a vehicle seat via a vehicle belt associated with the vehicle seat. Furthermore, the child seat can be connected to the support base 12, either permanently, or detachably so that the child seat can be removed from the support base 12 as needed. The support base 12 includes a base seat portion 24 and a base back portion 26. The base seat portion 24 and the base back portion 26 may be formed monolithically or formed as separate components that are coupled together. In some instances, the base 12 may include the base seat portion 24 and may exclude the base back portion 26. The support base 12 itself may be formed from rigid polymeric materials, including thermoplastics, thermosets, combinations of both, or composite materials.

The child restraint system 10 may be configured to allow rotation and/or inclination of the child seat 14 relative to the support base 12. For example, the system 10 may include an incline actuator 28 located along the support base 12 to control inclination of the child seat 14 about an inclination axis (not shown) that is generally perpendicular to the support base 12 when installed in the vehicle. Actuation of the inclination actuator 28 causes the child seat 14 to incline about the incline axis relative to the support base 12.

The child restraint system 10 may also include a rotation actuator 30 configured to rotate the child seat 14 relative to the support base 12. For example, the system 10 may include a rotation actuator 30 located along the child seat 14 that controls rotation of the child seat 14 about a rotation axis (not shown) that generally intersects the support base 12 when installed in the vehicle. Actuation of the rotation actuator 30 causes the child seat 14 to rotate about the rotation axis relative to the support base 12. Various features, elements, and implementations of the inclination actuator 28 and the rotation actuator 30 and related components of the child seat 14 and the support base 12 are disclosed in WO 2024/206806, the contents of which are incorporated by reference into the present disclosure.

Referring again to FIGS. 1-3, the car seat 14 includes a seat 16, a seat back panel (or assembly) 18, and a headrest 20 that is movable relative to the back panel 18. The car seat 14 may include softgoods attached thereto, which could include foam materials and textiles, such as woven and/or knit goods. FIGS. 1-7 do not illustrate the softgoods but the system 10 could include softgoods where the height indicator or indicators 22 are obstructed. The car seat 14 includes side impact protection panels 36 on either side of the back panel 18. One or more cup holders 38 are on the seat 16. The child seat 14 may include a harness assembly (not shown) that includes two shoulder straps connectable to at least one crotch strap via a buckle.

In the embodiment shown in FIGS. 1-3, the car seat 14 includes one or more height indicators 22 to illustrate the position of the headrest 20 among a plurality of headrest positions. In the example shown, a first height indicator 22 is a set of markings aligned in a vertical direction V along an edge of the back panel 18. An additional second height indicator 42 may be associated with the headrest to indicate a specific height relative to the first height indicator 22. The markings in indicator 22 are separated by fixed spacings between adjacent markings to help identify specific heights. The proposed markings would be placed on the seat back panel 18 of the child seat 14 such that they correspond to the location of the headrest 20, e.g., “1” being lowest position, “15” being highest position. This can also be beneficial for caregivers to consistently align the headrest 20 with the child (e.g., if a seat is used for two different children, or being reinstalled in different vehicles, etc.). The height indicator 22 can be any alphanumeric character or characters as needed, including letters, numbers, abbreviations, and/or words, or other symbols to identify a relative position.

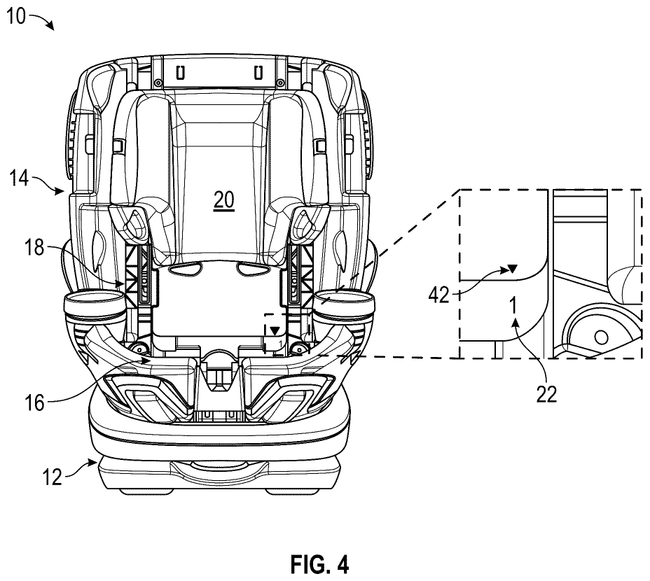

Referring to FIGS. 1-3, the car seat 14 includes a headrest assembly 32 that is movably coupled to the seat back panel 18. The headrest assembly 32 may include an additional height indicator 42 as further discussed below. The headrest assembly 32 includes the headrest 20, a headrest actuator (not shown), and coupling members (not shown) that movably couple the headrest 20 to the back panel 18. Here, actuation of the actuator causes the headrest 20 to move among any one of the plurality of positions relative to the seat back panel 18. The coupling members may include various devices, such as tracks, projections, bias members and the like that couple the headrest 20 to the back panel 18 and the actuator so that the headrest 20 can move as needed via actuation of the actuator. For example, the actuator may be coupled to a linkage (not shown) that can selectively release a lock from a track disposed along the back panel 18. Actuation of the actuator can release the lock so that the headrest 20 can be moved up or down relative to the back panel 18, as shown in FIGS. 4-7 as further explained below. The headrest adjustment assembly 32 may be similar to that described in WO 2024/206806, the contents of which are incorporated by reference into the present disclosure.

The headrest assembly 32 also includes a headrest panel 34 fixedly coupled to the headrest 20. The headrest panel 34 moves with the headrest 20 as needed and further provides a surface for height indicator 42. For example, the lower portion of the headrest panel 34 may include an indicator 42, such as an arrow, that identifies a particular position of the headrest 20 on the height indicator 22 on the back panel 18. The height indicator 22 on the headrest 20 can be any alphanumeric character, word, numbers, abbreviation, or symbol that can be used to identify the second height indicator 42 on the back panel 18.

In some embodiments the headrest height indicators are provided on hardgoods of the car seat (e.g., plastic shell, rigid foam components, headrest adjustment track, or the like) behind the softgoods. In other embodiments, some or all of the height indicators are provided on the softgoods.

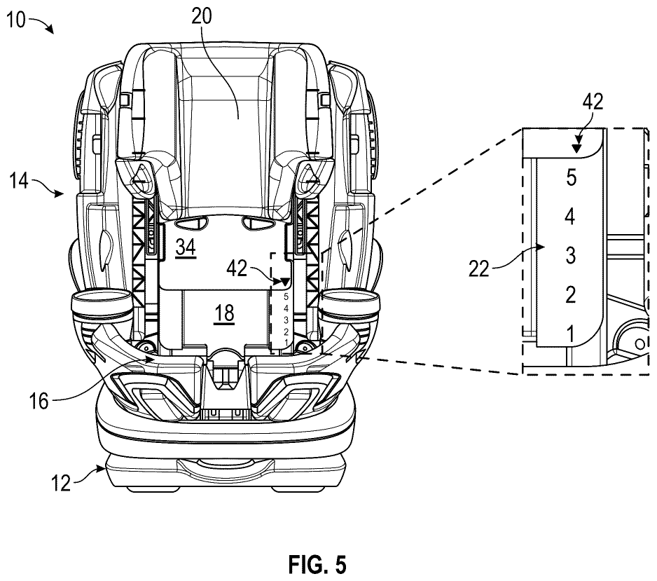

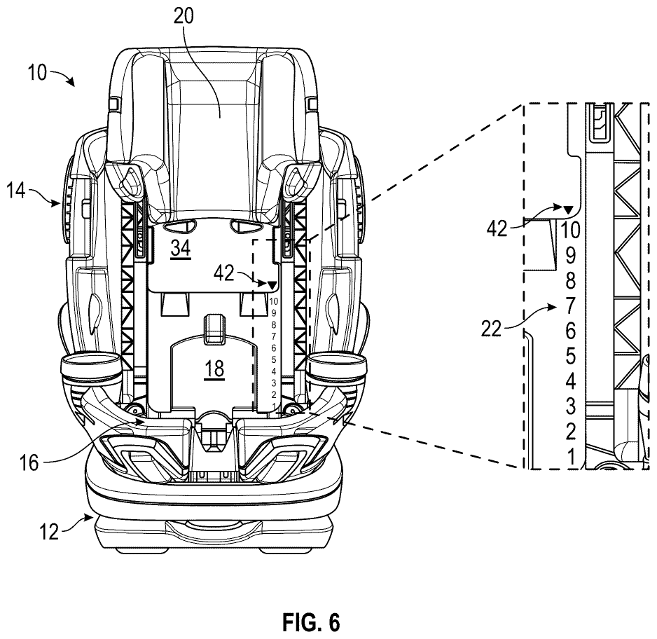

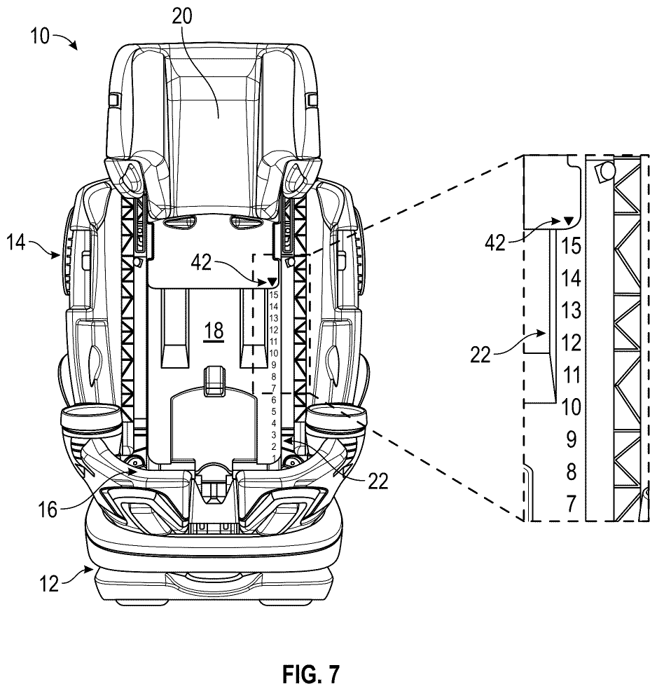

In certain embodiments shown in FIGS. 1-7, the indicator 22 includes a series of height marking numerals provided on the seat back panel 18 and a single arrow 42 is provided on the headrest 20 (e.g., a lower portion of the headrest 20). The headrest 20 may block some higher numbers of the markings depending on its position as described above. In this embodiment, as the headrest 20 moves upward, higher numbers of the height marking are revealed. For instance, the progression of FIGS. 4 through 7 illustrate the headrest 20 in the lowest position (FIG. 4) and the headrest 20 in its highest position (FIG. 7). In FIG. 4, the headrest 20 may be actuated to its lowest position as shown with headrest indicator 42 pointing the lowest position “1” on the back panel 18. In FIG. 5, the headrest actuator is actuated and the headrest 20 is moved to an intermediate position, with the headrest indicator 42 pointing to position “5” on the indicator 22 of the back panel 18. In FIG. 6, the headrest actuator is actuated and the headrest 20 is moved to another intermediate position, with the headrest indicator 42 pointing to position “10” on the indicator 22 of the back panel 18. In FIG. 7, the headrest actuator is actuated and the headrest 20 is moved to its highest position, with the headrest indicator 42 pointing to position “15” on the indicator 22 of the back panel 18. Thus, the headrest 20 is movable, to discrete positions along the back panel 18, between a lowest position (FIG. 4), one or more intermediate positions, and to a highest position, with each position corresponding to a particular marking, and therefore height of the headrest 20 relative to the back panel 18.

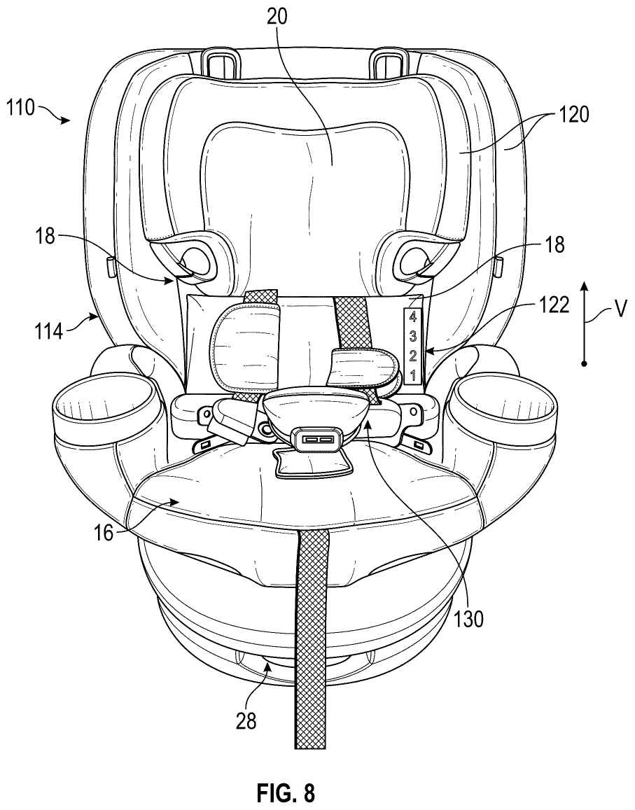

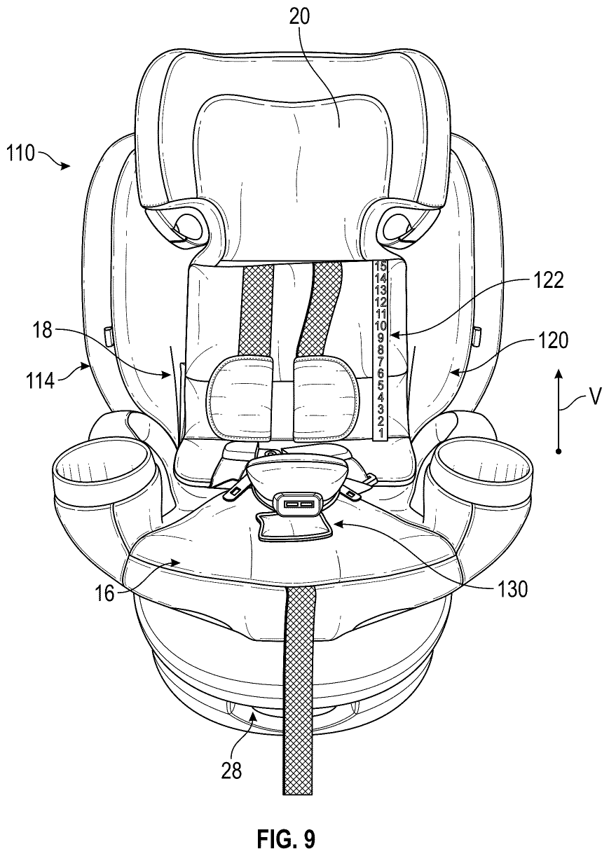

FIGS. 8 and 9 illustrate a child restraint system 110 according to another embodiment of the present disclosure that is illustrated with the softgoods. The child restraint system 110 shown in FIGS. 8-9 is substantially similar to the child restraint system shown in FIGS. 1-17 and common reference numbers are used to identify parts and components between the two embodiments that are similar to each other. Accordingly, the child restraint system 110 has a support base 12 and child car seat 114 associated with the support base 12. The child car seat 114 includes a seat 16, a seat back panel (or assembly) 18, and a headrest 20 that is movable relative to the back panel 18 in a vertical direction V, and softgoods 120 along each portion of the child seat 114. The child car seat 114 may include a harness assembly 130 that includes two shoulder straps connectable to at least one crotch strap via a buckle. The child restraint system 110 may also be configured to allow rotation and/or inclination of the child seat 114 relative to the support base 12. For example, the system 110 may include an incline actuator 28 located along the support base 12 to control inclination of the child seat 114. In addition, the child restraint system 110 may include a rotation actuator (not shown) configured to rotate the child seat 114 relative to the support base 12. Furthermore, the child restraint system 110, including the child seat 114, its adjustable headrest 20, its harness assembly 130, and one or more of the optional inclination and rotation actuators may be similar to that as disclosed in WO 2024/206806, the contents of which are incorporated by reference into the present disclosure. However, other variations of a child restraint system and car seat could be used and the child restraint system and car seat disclosed in the present application are not the only types of such systems contemplated by the inventors as included within the scope of the present disclosure or claims.

As shown in FIGS. 8 and 9, the car seat 114 may include one or more height indicators 122 disposed along an outer surface 118 of the softgoods 120 along the back panel 18. In the embodiment shown in FIGS. 8-9, an example of a height indicator 122 being visible without moving or removing the softgoods is shown. The height indicator 122 is used to identify a specific height position of the headrest 20 relative to the seat back panel 18. More specifically, the headrest 20 is adjustable to a plurality of positions relative to the seat back panel 18 and the height indicator 122 can display which one the plurality of positions the headrest 20 is placed relative to the seat back panel 18. This in turn allows the car seat 114 to be adjusted to account for growth of the child so the headrest 20 is in the proper position for that child thereby ensuring that the safety protocols and features built into the child restraint system 110 are appropriately matched to the size of the user in the car seat 114. The progression of FIGS. 8 and 9 illustrate the headrest 20 in an intermediate position (FIG. 8) and the headrest 20 in its highest position (FIG. 9). In FIG. 8, the headrest actuator is actuated and the headrest 20 is moved to an intermediate position, with the headrest 20 aligned with position “5” on the indicator 122 of the back panel 18 of the softgoods 130. In FIG. 9, the headrest actuator is actuated and the headrest 20 is moved to its highest position, with the headrest 20 aligned at position “15” on the indicator 122 of the back panel 18. Thus, the headrest 20 is movable, to discrete positions along the back panel 18, between a lowest position (FIG. 4), one or more intermediate positions, and to a highest position, with each position corresponding to a particular marking, and therefore height of the headrest 20 relative to the back panel 18.

Accordingly, embodiments of the present disclosure include a child seat for a child restraint system that include one or more height indicators located along a back panel of the child seat, for example on hard goods, and a headrest (e.g. an arrow or other shape). In such an example, the child seat can be designed so that the softgoods hide the height indicator but can be visible if the user moves part of the softgoods out of the way to reveal the indicator. In another example, the softgoods and the back panel can be constructed so the height indicator is on the back panel, such as a hardgoods, and there is no need to remove or move a portion of the softgoods to see the height indicator. In addition, embodiments of the present disclosure include a child car seat for a child restraint system that includes one or more height indicators located on a softgoods along the back panel of the child seat. Furthermore, embodiments of the present disclosure include a car seat with one or more height indicators disposed along an outer surface of the softgoods. In such an example, the height indicator is visible without moving or removing the softgoods. In any embodiment, there may be two indictors, one which identifies different positions of the headrest and another on the headrest or part of the headrest assembly that identifies which specific position the headrest is located.

In still other embodiments, the present disclosure could include a headrest assembly for a child seat of a child restraint system. In such an example, the headrest assembly includes a headrest movably mounted to the seat back panel, with the headrest adjustable to a plurality of positions relative to the seat back panel. The headrest may include an indicator to identify the height of the headrest relative to the back panel. The back panel itself can include a height indicator for showing in which of the plurality of positions the headrest is placed relative to the seat back panel.

Certain terminology is used in the following description for convenience only and is not limiting. As used herein, the terms “forward”, “rearward”, “upper”, and “lower” designate directions in the drawings to which reference is made. The terms “inwardly” and “outwardly” refer to directions towards and away from parts referenced in the drawings. “Axially” refers to a direction along the axis of a shaft (or centerline of an object). “Laterally” refers to a direction perpendicular to the axis of the shaft (or centerline of the object) from one side to another opposite side. A reference to a list of items that are cited as “at least one of a, b, or c” (where a, b, and c represent the items being listed) means any single one of the items a, b, or c, or combinations thereof. The term “substantially” when used in connection with, for example, a geometric relationship, a numerical value, and/or a range is intended to convey that the geometric relationship (or the structures described thereby), the number, and/or the range so defined is nominally the recited geometric relationship, number, and/or range. For example, two structures described herein as being “substantially parallel” is intended to convey that, although a parallel geometric relationship is desirable, some non-parallelism can occur in a “substantially parallel” arrangement. The terms “about” and “approximately” are to be construed to be plus or minus up to 10% of a stated value or ratio. The terminology includes the words specifically noted above, derivatives thereof, and words of similar import.

While the disclosure is described herein, using a limited number of embodiments, these specific embodiments are not intended to limit the scope of the disclosure as otherwise described and claimed herein. The precise arrangement of various elements and order of the steps of articles and methods described herein are not to be considered limiting. For instance, although the steps of the methods are described with reference to sequential series of reference signs and progression of the blocks in the figures, the method can be implemented in an order as desired. Additionally, features identified or discussed with respect to one set of figures may be additionally or alternatively applied to any other set of figures or embodiments disclosed herein.

What is claimed is:

1. A child restraint system, comprising:
a base configured for securement to a seat in a vehicle;
a child seat coupled to the base, the child seat having a seat portion and a seat back panel;
a headrest movably mounted to the seat back panel, wherein the headrest is adjustable to a plurality of positions relative to the seat back panel; and
one or more height indicators for showing in which of the plurality of positions the headrest is placed relative to the seat back panel.

2. The child restraint system according to claim 1, wherein the one or more height indicators is aligned with the seat back panel.

3. The child restraint system according to claim 1, wherein the one or more height indicators is disposed along or aligned with a lower portion of the headrest.

4. The child restraint system according to claim 1, further comprising softgoods coupled to the child seat, wherein one or more height indicators is located behind the softgoods.

5. The child restraint system according to claim 1, further comprising softgoods coupled to the child seat, wherein one or more height indicators is located along an edge of the seat back panel.

6. The child restraint system according to claim 1, further comprising softgoods coupled to the child seat, wherein one or more height indicators is located on the softgoods.

7. The child restraint system according to claim 1, wherein a majority of one or more height indicators is obstructed by the headrest when the headrest is in its lowermost position of the plurality of positions.

8. The child restraint system according to claim 1, wherein a majority of one or more height indicators is exposed when the headrest is in its highest position of the plurality of positions.

9. The child restraint system according to claim 1, wherein one or more height indicators includes a plurality of markings separated by fixed spacings between adjacent markings.

10. The child restraint system according to claim 9, wherein the plurality of markings are alphanumeric characters.

11. The child restraint system according to claim 1, wherein the plurality of positions are distinct positions of the headrest relative to the seat back panel.

12. The child restraint system according to claim 1, further comprising:
a headrest assembly that movably couples the headrest relative to the seat back panel, and
a headrest actuator, wherein actuation of the actuator causes the headrest to move among any one of the plurality of positions.

13. The child restraint system according to claim 1, further comprising a harness assembly for restraining a child within the child seat.

14. A child car seat, comprising:
a seat portion;
a seat back panel;
a headrest movably mounted to the seat back panel, wherein the headrest is adjustable to a plurality of positions relative to the seat back panel; and
one or more height indicators for showing in which of the plurality of positions the headrest is placed relative to the seat back panel.

15. The child car seat according to claim 14, wherein the one or more height indicators is aligned with the seat back panel.

16. The child car seat according to claim 14, wherein the one or more height indicators is disposed along or aligned with a lower portion of the headrest.

17. The child car seat according to claim 14, further comprising softgoods, wherein one or more height indicators is located behind the softgoods.

18. The child car seat according to claim 14, wherein one or more height indicators is located along an edge of the seat back panel.

19. The child car seat according to claim 14, further comprising softgoods, wherein one or more height indicators is located on the softgoods.

20. The child car seat according to claim 14, wherein a majority of one or more height indicators is obstructed by the headrest when the headrest is in its lowermost position of the plurality of positions.

21. The child car seat according to claim 14, wherein a majority of one or more height indicators is visually exposed when the headrest is in its highest position of the plurality of positions.

22. The child car seat according to claim 14, wherein one or more height indicators includes a plurality of markings separated by fixed spacings between adjacent markings.

23. The child car seat according to claim 22, wherein the plurality of markings are alphanumeric characters.

24. The child car seat according to claim 14, wherein the plurality of positions are distinct positions of the headrest relative to the seat back panel.

25. The child car seat according to claim 14, further comprising a headrest assembly that movably couples the headrest relative to the seat back panel, and a headrest actuator, wherein actuation of the actuator causes the headrest to move among any one of the plurality of positions.
